(19) United States
(12) Patent Application Publication
(10) Pub. No.: US 2015/0316786 A1
(43) Pub. Date: Nov. 5, 2015

(54) EYEWEAR WITH FACETED LENSES

(71) Applicant: Pamela Tietze, Brooklyn, NY (US)

(72) Inventor: Pamela Tietze, Brooklyn, NY (US)

(21) Appl. No.: 14/267,132

(22) Filed: May 1, 2014

(51) Int. Cl. G02C 7/02

(52) U.S. Cl. CPC G02C 7/02

(57) ABSTRACT

An eyewear with faceted lenses includes an eyewear frame, and a pair of lenses fitted against the eyewear frame. Each lens has a first surface and a second surface. The first surface of each lens is faceted, and the second surface of each lens is not faceted.

### FIELD

The present disclosure relates to eyewear with faceted lenses.

### SUMMARY

One aspect of this disclosure features eyewear that includes an eyewear frame. A pair of lenses is fitted against the frame. Each lens has a first surface and a second surface. The first surface of each lens is faceted, and the second surface of each lens is not faceted

In some implementations, the pair of lenses is made of a plastic or glass.

In some implementations, the first surface of each lens is convex.

In some implementations, the second surface of each lens is concave.

In some implementations, the second surface of each lens is convex.

In some implementations, the second surface of each lens is substantially flat.

In some implementations, the first surface of each lens is faceted in a symmetrical arrangement.

In some implementations, the first surface of each lens is faceted as a portion (e.g., a top portion) of a round brilliant-cut diamond.

In some implementations, the first surface of each lens is faceted in a pixel arrangement.

In some implementations, the first surface of each lens is coated with an iridescent coating.

In some implementations, each lens is detachable from the eyewear frame.

In some implementations, the first surface of each lens faces away from a user when the user is wearing the eyewear.

In some implementations, the first surface of each lens faces toward a user when the user is wearing the eyewear.

In some implementations, the diameter of each lens ranges from about 45 mm to about 50 mm.

### BRIEF DESCRIPTION OF THE DRAWINGS

FIG. 1 is a perspective view of an embodiment of eyewear with faceted lenses wherein a surface of each lens is faceted in a gemstone-like pattern.

FIG. 2 is a front view of an embodiment of eyewear with faceted lenses wherein a surface of each lens is faceted as a top portion of a round brilliant-cut diamond.

FIG. 3 is a perspective view of an embodiment of eyewear with faceted lenses wherein a surface of each lens is faceted in a pixel pattern.

FIG. 4 is an example depicting a user's view of an image through a conventional lens that is not faceted.

FIG. 5 is an example depicting a user's view of the image of FIG. 4 through a lens with faceting on one surface of the lens.

FIG. 6 is an example depicting a user's view of the image of Fig, 4 through a lens with faceting on both surfaces of the lens.

FIG. 7 is an example depicting a user's view of the image of FIG. 4 through a faceted lens, with the faceted surface facing away from the user, wherein the faceted surface is faceted as a top portion of a round brilliant-cut diamond.

FIG. 8 is an example depicting a user's view of the image of FIG. 4 through a faceted lens, with the faceted surface facing away from the user, wherein the faceted surface is faceted in a pixel pattern.

FIG. 9 is an example depicting a user's view of the image of FIG. 4 through a faceted lens, with the faceted surface facing towards the user, wherein the faceted surface is faceted in a pixel pattern.

### DETAILED DESCRIPTION

Eyewear with faceted lenses is disclosed herein. The eyewear creates visually stimulating effects including kaleidoscopic effects. Only one surface of each lens is faceted.

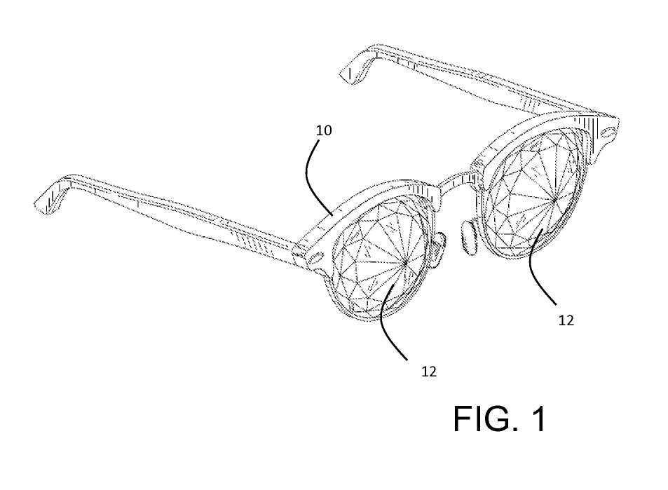

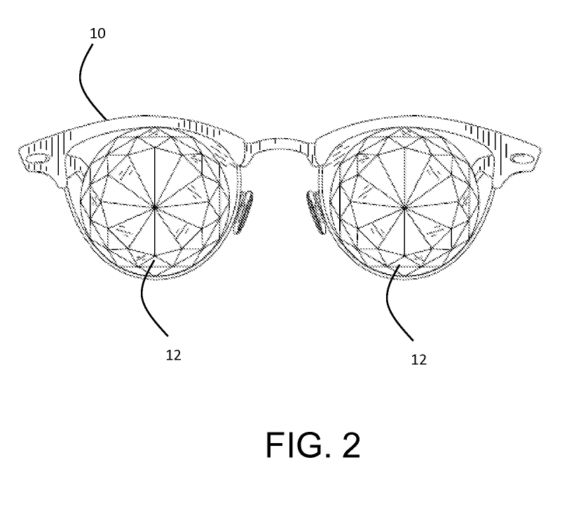

Referring to FIGS. 1 and 2, eyewear with faceted lenses includes an eyewear frame 10.

The eyewear frame 10 can be made of, for example, a plastic, a metal, or a combination thereof. The eyewear frame 10 can be, for example, the frame of a pair of sunglasses.

The pair of lenses 12 is fitted against the eyewear frame 10. For each lens 12, the surface facing away from the user when the eyewear is worn is faceted, and the surface facing toward the user when the eyewear is worn is not faceted. The lenses 12 are commercially available and formed by methods commonly known in the art, for example by methods used in crystal manufacturing. The lenses 12 can be made of, for example, a plastic or glass. In some implementations, the lenses are created using a mold that is filled with glass. The lenses 12 can also be adapted from, for example, commercially available chandelier prisms.

In some implementations, the diameter of the lenses can range from about 45 mm to about 50 mm.

In some implementations, each lens 12 is detachable from eyewear frame 10, allowing the user to choose which way the faceted side of each lens is facing, either towards the user or away from the user.

The faceted surface of each lens 12 is convex. In other implementations, the faceted surface of each lens 12 is not convex, and the surface of each lens 12 which is not faceted can be convex, concave, or substantially flat.

In some implementations, the faceted surface of each lens is coated with an iridescent coating.

The facet arrangement on the faceted surface of each lens 12 is the same as the facet arrangement on a top portion of a round brilliant-cut diamond.

In some implementations, the facet arrangement of the faceted surface of each lens 12 is symmetrical.

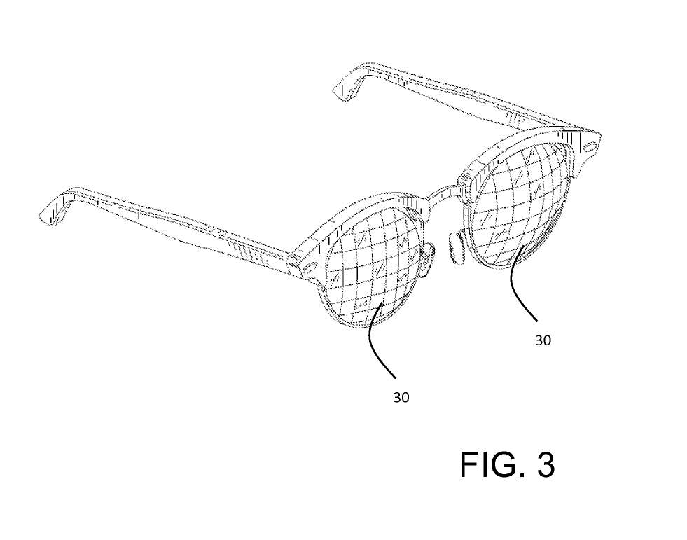

Referring to FIG. 3, the facet arrangement on the faceted surface of each lens 30 is in a pixel pattern.

In some implementations, the surface facing away from the user when the eyewear is worn is not faceted, and the surface facing toward the user when the eyewear is worn is faceted.

A number of embodiments of the invention have been described. Nevertheless, it will be understood that various modifications may be made without departing from the spirit and scope of the invention. For example, the shape and size, both relative and actual, of various parts of the eyewear with faceted lenses can be varied considerably. In addition, many different facet arrangements can be chosen for the faceted surfaces of the lenses.

Certain implementations may provide various advantages. For example, eyewear with faceting on only one surface of each lens is more light weight than eyewear with faceting on both surfaces of each lens. Also, eyewear with faceting on only one surface of each lens creates visually stimulating effects that are reduced in intensity, for example, by being less visually complex and providing the user with a greater degree of normal sight, compared to eyewear with faceting on both surfaces of each lens.

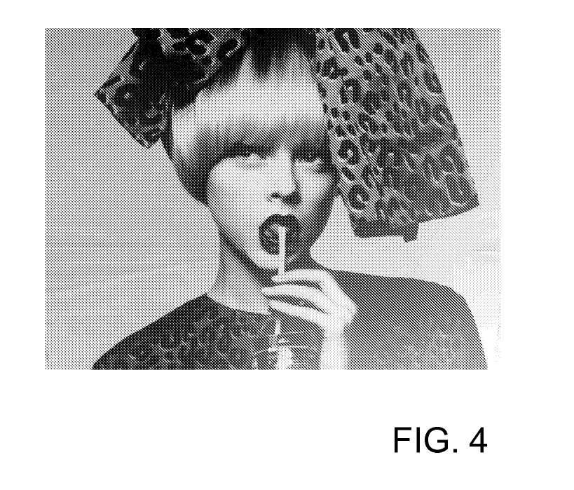

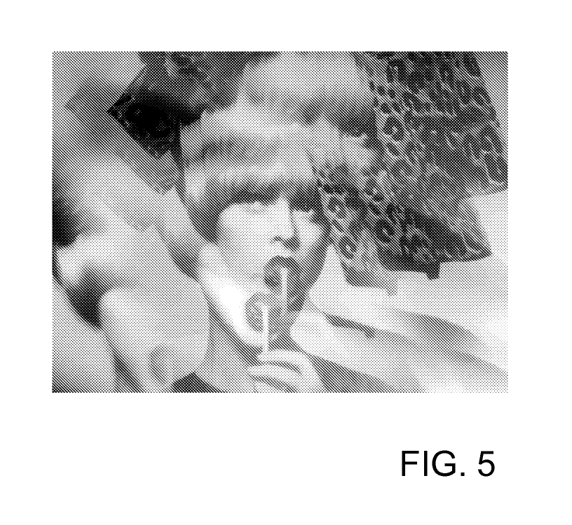

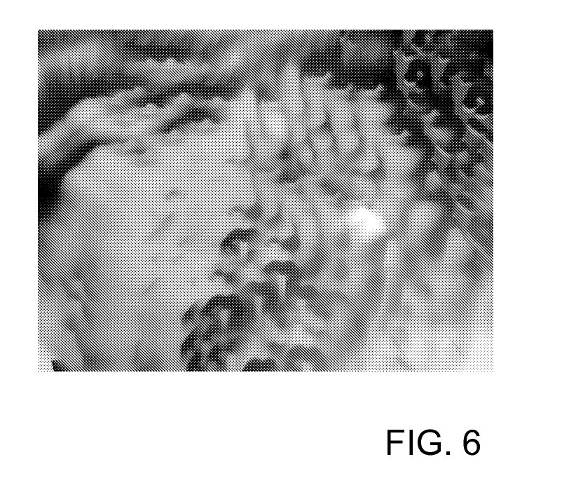

FIG. 4 is an example depicting a user's view of an image though a conventional lens that is not faceted. FIG. 5 is an example depicting a user's view of the image of FIG. 4 through a faceted lens, wherein one surface of the lens is faceted. FIG. 6 is an example depicting a user's view of the image of FIG. 4 through a faceted lens, wherein both surfaces of the lens are faceted.

FIGS. 5 and 6 show that a lens having only one faceted surface can significantly reduce the intensity of visual effects on an image viewed by a user through the lens compared to a lens having both surfaces faceted. FIG. 5 shows that when only one side of the lens is faceted, the user has a visual reference point for reality. In comparison, FIG. 6 shows that when both sides of the lens are faceted, the user's view is refracted through two sets of facets, resulting in the user having a more difficult time establishing a visual reference point.

Thus, because of the lighter weight of eyewear with faceting on only one surface of each lens, and the greater degree of normal sight provided by such eyewear, this eyewear is more suitable to be worn by the user in daily life or while performing everyday activities than eyewear with faceting on both surfaces of each lens.

In certain implementations, when the surface of the lens that is not faceted is flat, a camera lens can be put against this flat surface to take photographs with visual effects. Because the lens of the eyewear has this flat surface, it is easier to put the camera lens flush against the lens of the eyewear than if the lens of the eyewear had faceting on both surfaces.

In certain implementations, when the faceted surface of the lens is facing towards the user, the eyewear can have the appearance of eyewear with lenses that have holographic stickers placed on them, rather than faceted lenses. Lenses with holographic stickers placed on them create different visual effects than faceted lenses, thus people can be surprised when putting on the eyewear and experiencing unexpected visual effects.

In certain implementations, when the faceted surface of the lens is facing away from the user, the eyewear can be more comfortable for the user than when the faceted surface of the lens is facing toward the user because, for example, there is less of a chance that the lenses will touch the user's face or eyelashes, or there is less of a sensation that an object is close to the user's eyes.

In certain implementations, when the faceted surface of the lens is coated with an iridescent coating, and the other surface of the lens is not coated with an iridescent coating, the eyewear creates various visual effects for the user and for people viewing the eyewear on the user. For example, the iridescent coating on the lens increases the reflectiveness of the surface. Thus, when the faceted surface of the lens with the iridescent coating is facing towards the user, the user has an enhanced ability to see a reflection of the view behind the user. Also, people viewing the eyewear worn on the user will be able to see the internal thickness of the lens since the surface of the lens facing away from the user does not have an iridescent coating. When the faceted surface of the lens with the iridescent coating is facing away from the user, a visual effect is created for people viewing the eyewear on a user whereby the people are more likely to see a reflection, and will have difficulty seeing the eyes of the user and the internal thickness of the lens.

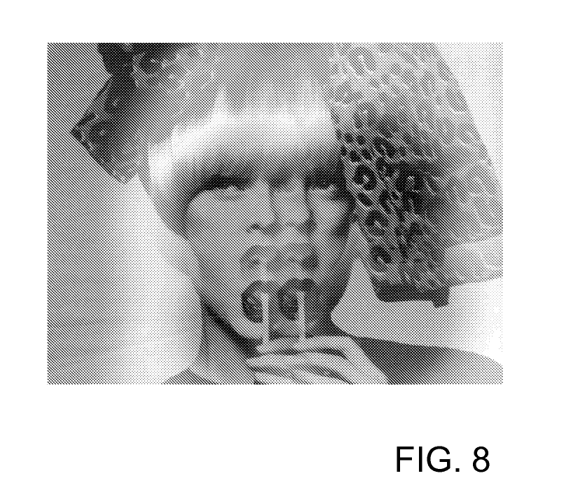

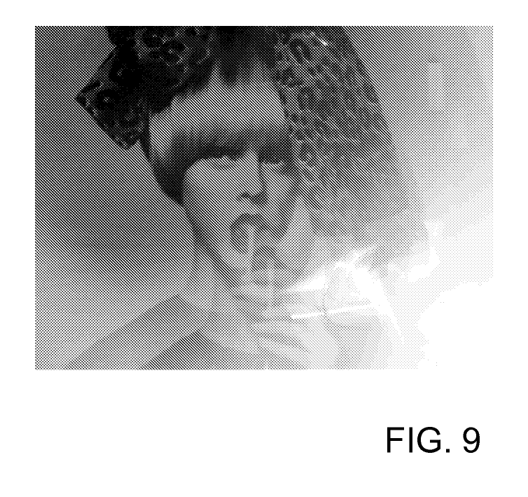

In certain implementations, the pair of lenses is detachable from the eyewear frame. Thus, for example, the faceted surface of each lens, for one or both of the lenses, can be switched from facing away from the user to facing towards the user, or vice-versa, thereby allowing the user to change the visual effect of the eyewear on the user and on people viewing the eyewear worn on the user. For example, FIG. 8 is an example depicting a user's view of the image of FIG. 4 through a faceted lens, with the faceted surface facing away from the user, wherein the faceted surface is faceted in a pixel pattern. FIG. 9 is an example depicting a user's view of the image of FIG. 4 through a faceted lens, with the faceted surface facing towards the user, wherein the faceted surface is faceted in a pixel pattern. Comparing FIGS. 8 and 9, the visual effect of the lens on the user when the faceted surface is facing away from the user is different from the visual effect of the lens on the user when the faceted surface is facing towards the user. The image in FIG. 8 is broken up in a different pattern than the image of FIG. 9. Thus, the user can enjoy the advantages of both having the faceted surface of each lens facing towards the user and having the faceted surface of each lens facing away from the user.

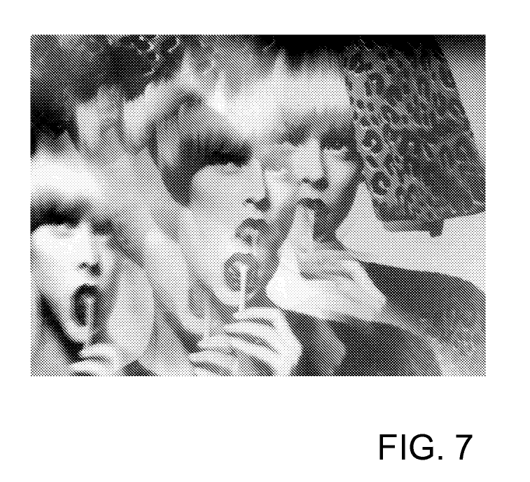

In addition, each lens may be swapped with other lenses, including lenses with other faceting arrangements that create other visual effects. For example, each lens may be swapped with a lens with a different level of intensity. When a lens has a faceting arrangement that creates a visual effect that is less complex and provides the user a greater degree of normal sight, it is said to have a lower level of intensity than a faceting arrangement that creates a visual effect that is more complex and provides the user with a lesser degree of normal sight. FIG. 7 is an example depicting a user's view of the image of FIG. 4 through a faceted lens, with the faceted surface facing away from the user, wherein the faceted surface is faceted as a top portion of a round brilliant-cut diamond. FIG. 8 is an example depicting a user's view of the image of FIG. 4 through a faceted lens, with the faceted surface facing away from the user, wherein a surface of the lens is faceted in a pixel pattern. FIGS. 7 and 8 show that a faceted lens wherein the faceted surface is faceted as a top portion of a round brilliant-cut diamond has a higher intensity than a faceted lens wherein the faceted surface is faceted in a pixel pattern. The visual distortion seen in FIG. 7 is greater than the visual distortion seen in FIG. 8. For example, the image in FIG. 7 is more broken up than that in FIG. 8. In addition, it would be more difficult for the user to establish a point of perspective or field of depth by using a faceted lens in which the faceted surface is faceted as a top portion of a round brilliant-cut diamond compared to a faceted lens in which the faceted surface is faceted in a pixel pattern.

Other implementations are within the scope of the following claims.

What is claimed is:

1. Eyewear, comprising:
an eyewear frame; and
a pair of lenses fitted against the eyewear frame;
wherein each lens has a first surface and a second surface;
the first surface of each lens is faceted; and
the second surface of each lens is not faceted.

2. The eyewear of claim 1, wherein the pair of lenses is made of a plastic or glass.

3. The eyewear of claim 1, wherein the first surface of each lens is convex.

4. The eyewear of claim 1, wherein the second surface of each lens is concave.

5. The eyewear of claim 1, wherein the second surface of each lens is convex.

6. The eyewear of claim 1, wherein the second surface of each lens is substantially flat.

7. The eyewear of claim 1, wherein the first surface of each lens is faceted in a symmetrical arrangement.

8. The eyewear of claim 1, wherein the first surface of each lens is faceted as a portion of a round brilliant-cut diamond.

9. The eyewear of claim 1, wherein the first surface of each lens is faceted in a pixel arrangement.

10. The eyewear of claim 1, wherein the first surface of each lens is coated with an iridescent coating.

11. The eyewear of claim 1, wherein each lens is detachable from the eyewear frame.

12. The eyewear of claim 1, wherein the first surface of each lens faces away from a user when the user is wearing the eyewear.

13. The eyewear of claim 1, wherein the first surface of each lens faces toward a user when the user is wearing the eyewear.

14. The eyewear of claim 1, wherein the diameter of each lens ranges from about 45 mm to about 50 mm.
